(19) United States
(12) Patent Application Publication
(10) Pub. No.: US 2006/0004857 A1
(43) Pub. Date: Jan. 5, 2006

(54) Method, system and program product for normalization of database result sets

(75) Inventors: Brent H. Daniel, Morrisville, NC (US); Timo J. Salo, Cary, NC (US); Kevin J. Williams, Colorado Springs, CO (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/883,508

(22) Filed: Jul. 1, 2004

(51) Int. Cl. G06F 17/00

(52) U.S. Cl. 707/103 Y

(57) ABSTRACT

Under the present invention, a system, method, and program product are provided for the normalization of database result sets. The method comprises: transforming a row in the database result set into a set of data objects using information from the database result set and metadata corresponding to the result set; establishing links between the data objects by iterating through relationships defined in the metadata; and generating a graph of related data objects based on the links.

### BACKGROUND OF THE INVENTION

1. Field of the Invention

The present invention generally relates to relational databases. More particularly, the present invention provides a method, system and program product for normalization of database result sets, such as Java Database Connectivity (JDBC) ResultSets.

2. Related Art

Relational database queries are often used to return information from several tables at once. The information is returned in a flat, tabular format that does not represent the relationships between tables in the database. When data is returned in this format, users have to spend considerable time transforming the data back into a normalized format that more closely resembles the underlying database. An example of a flat, tabular format JDBC ResultSet 10 is illustrated in FIG. 1. As known in the art, JDBC is a Java API (a standard set of Java classes) that enables Java programs to execute SQL statements. This allows Java programs to interact with any SQL-compliant database. A JDBC ResultSet is a table of data representing a database result set, which is usually generated by executing a statement that queries a database.

The JDBC ResultSet 10 illustrated in FIG. 1 comprises four columns: Department 12, Employee Name 14, Hire Date 16 and Zip Code 18. Thus, referring to row 20 of ResultSet 10, it can be ascertained that the employee “Sam” works in the “Shoe Department,” was hired on “10/27/1989,” and has an address with a zip code of “27560.”

In order to extract a list of the employees in ResultSet 10 that work in the “Shoe department,” and to provide the list in a usable format, specialized code such as that listed below could be used:

while (resultSet.next( )) {

String department = resultSet.getString(1);
if( department.equals(“Shoe Department”)) {

String employeeName = resultSet.getString(2);
employees.add(employeeName);

}

This code iteratively examines each entry of ResultSet 10 for the string “Shoe Department,” and, if found, extracts the corresponding name of the employee and adds that name to the string “employeeName.” Similar specialized code must be provided to extract other information from ResultSet 10 and to provide that information to a user in a usable format. Thus, there is a need to reduce or eliminate the requirement for users to write specialized code to transform database result sets (e.g., a JDBC ResultSets) into a usable format.

### SUMMARY OF THE INVENTION

In general, the present invention provides a method, system, and program product for normalization of database result sets, such as Java Database Connectivity (JDBC) ResultSets.

A first aspect of the present invention is directed to a method for normalizing a database result set, comprising: transforming a row in the database result set into a set of data objects using information from the database result set and metadata corresponding to the result set; establishing links between the data objects by iterating through relationships defined in the metadata; and generating a graph of related data objects based on the links.

A second aspect of the present invention is directed to a system for normalizing a database result set, comprising: a system for transforming a row in the database result set into a set of data objects using information from the database result set and metadata corresponding to the result set; a system for establishing links between the data objects by iterating through relationships defined in the metadata; and a system for generating a graph of related data objects based on the links.

A third aspect of the present invention is directed to a program product stored on a recordable medium for normalizing a database result set, which when executed, comprises: program code for transforming a row in the database result set into a set of data objects using information from the database result set and metadata corresponding to the result set; program code for establishing links between the data objects by iterating through relationships defined in the metadata; and program code for generating a graph of related data objects based on the links.

A fourth aspect of the present invention is directed to a system for deploying an application for normalizing a database result set, comprising: a computer infrastructure being operable to: transform a row in the database result set into a set of data objects using information from the database result set and metadata corresponding to the result set; establish links between the data objects by iterating through relationships defined in the metadata; and generate a graph of related data objects based on the links.

A fifth aspect of the present invention provides computer software embodied in a propagated signal for normalizing a database result set, the computer software comprising instructions to cause a computer system to perform the following functions: transform a row in the database result set into a set of data objects using information from the database result set and metadata corresponding to the result set; establish links between the data objects by iterating through relationships defined in the metadata; and generate a graph of related data objects based on the links.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an example of a flat, tabular format JDBC ResultSet.

FIG. 2 depicts metadata containing information about relational database tables, columns, keys, and relationships.

FIG. 3 depicts a flow diagram of the steps of the data transformation provided by the present invention.

FIGS. 4a-4f illustrate a data transformation of the JDBC ResultSet shown in FIG. 1 into a graph of related data objects, in accordance with the present invention.

FIG. 5 illustrates a computer system for implementing the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and program product for normalization of database result sets, such as Java Database Connectivity (JDBC) ResultSets. It is assumed for the purposes of this description that the reader has an understanding of databases, database schemas, Java, and JDBC commensurate with one skilled in the art. Accordingly, a detailed description of these topics is not provided herein.

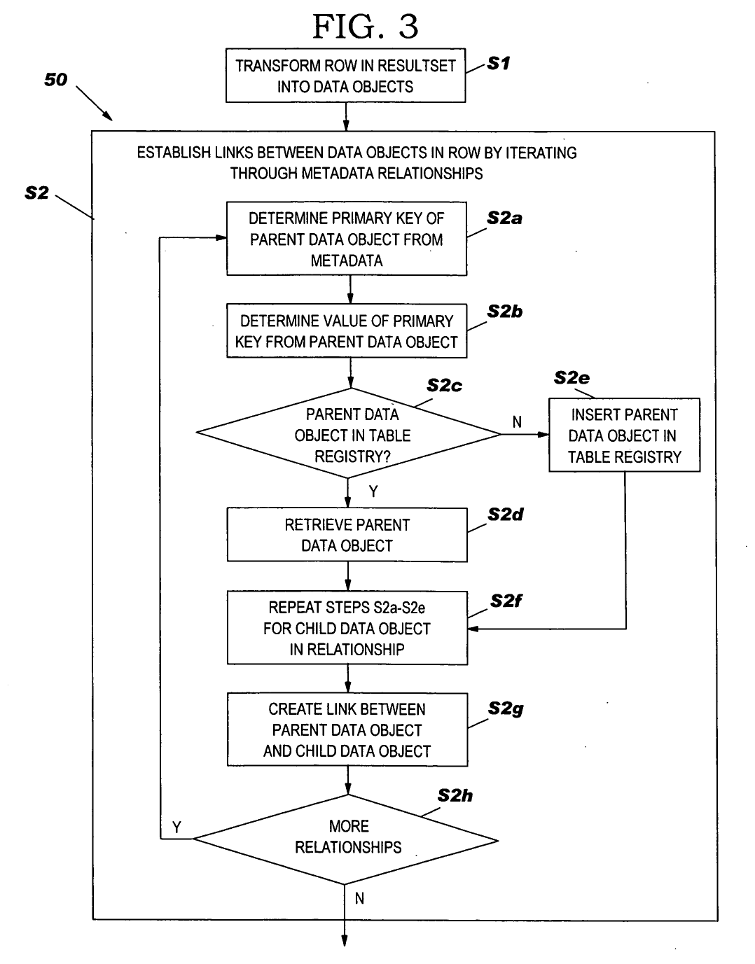

The present invention utilizes information provided by a user to transform data within a ResultSet into a graph of related data objects. The information provided by the user is a description of a subset of a database schema used in the query that generated the ResultSet. As shown in FIG. 2, this “metadata” 30 contains information about the relational database tables 32, columns 34, keys 36, and relationships 38. Generally, as shown in FIG. 2, a plurality of tables 32 and relationships 38 can be contained within the schema. In addition, a plurality of columns 34 and keys 36 can be contained within each table 32. The keys 36 include a single primary key 40 and can include a plurality of foreign keys 42. Each key 36 can contain one or more columns 34 of a table 32. Finally, each relationship 38 includes a parent key 44 and a child key 46.

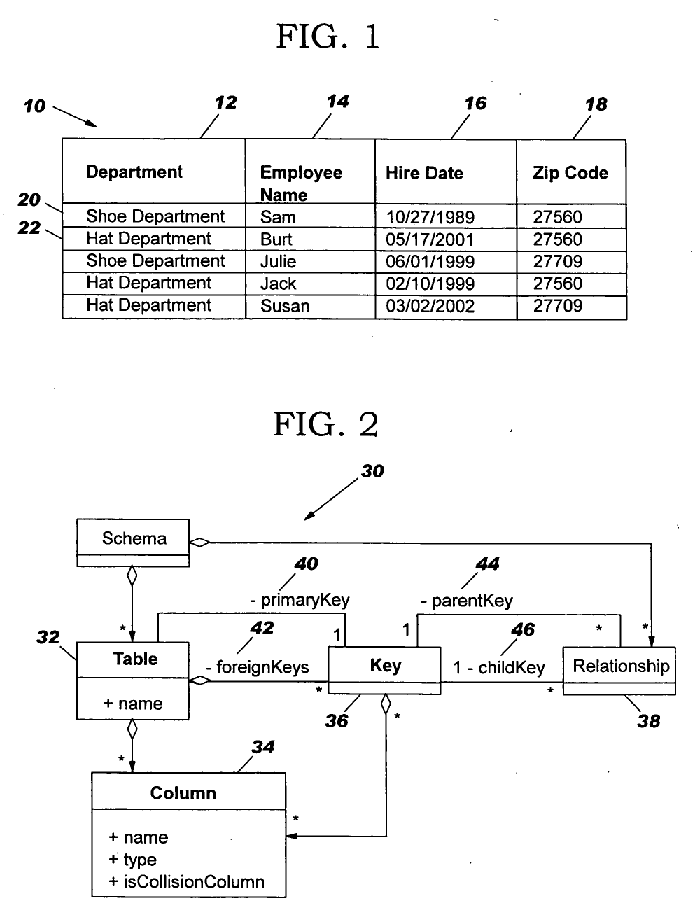

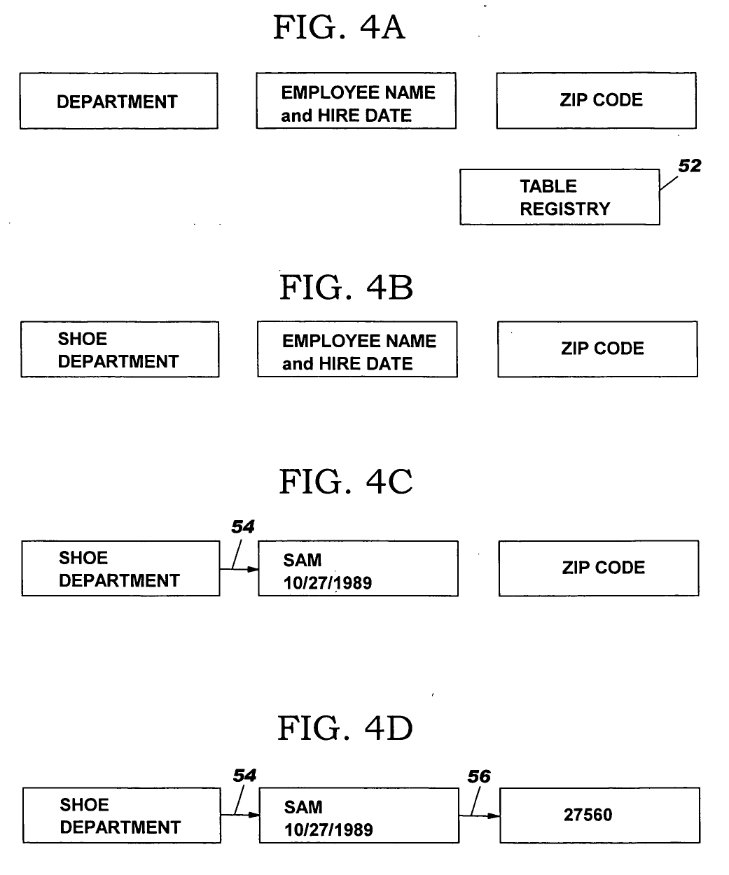

A flow diagram 50 illustrating the steps of the transformation provided by the present invention is illustrated in FIG. 3. In step S1, a row in a tabular ResultSet is transformed into a set of “data objects” using information from both the ResultSet and the metadata (e.g., metadata 30 (FIG. 2)) corresponding to the ResultSet. For example, row 20 of the ResultSet 10 of FIG. 1 can be transformed into the data objects “Department,” “Employee Name” (including hire date), and “Zip Code.” In step S2, for this row of newly created data objects, links are established between the data objects by iterating through the relationships defined in the metadata 30. In particular, in step S2a, the primary key of the parent data object is determined from the metadata 30. For example, for the relationship between “Department” and “Employee Name” in row 20 of ResultSet 10, the primary key of the parent data object is the department name. In step S2b, the value of the primary key is obtained from the parent data object. In the above example, the department name (e.g., “Shoe Department”) is retrieved from the “Department” data object on the current row. In step S2c, if the parent data object exists in a table registry, it is retrieved in step S2d based on the value of its primary key. If the parent data object does not exist in the table registry, the current data object is inserted into the table registry in Step S2e. In step S2f, steps S2a through S2e are repeated for the child data object in the relationship, and in step S2g, a link is created between the parent data object and the child data object. In step S2h, this process is repeated for each relationship in the row. Each row in the ResultSet is processed in this manner. Since data objects are retrieved from the table registry based on their unique primary key, data objects will not be duplicated in the final graph.

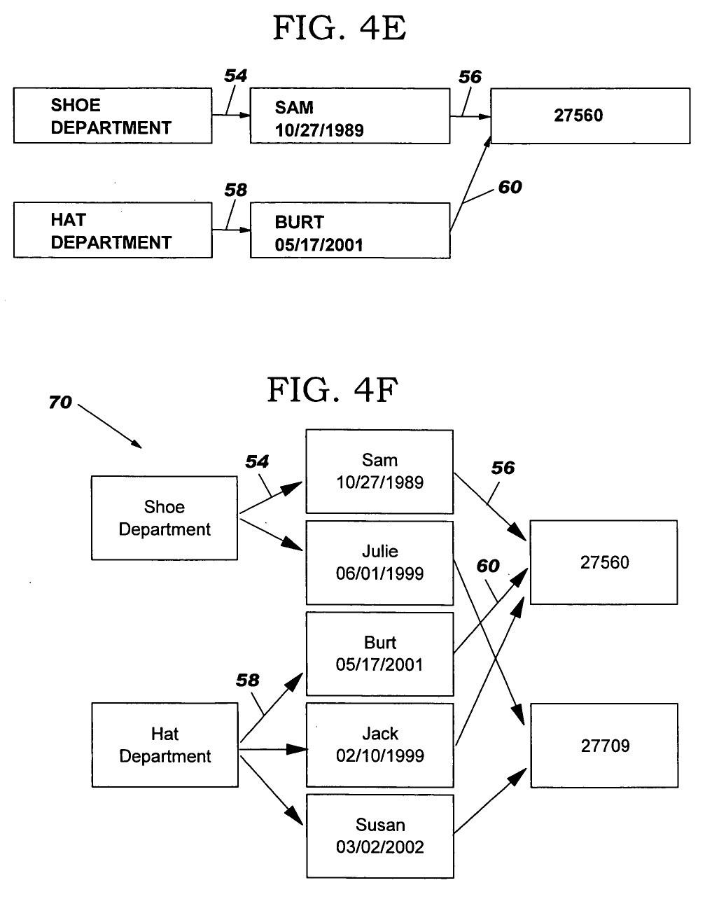

The process illustrated in the flow diagram 50 of FIG. 3 is illustrated in more detail in FIGS. 4a-4f.

In FIG. 4a, row 20 of ResultSet 10 has been transformed into the data objects “Department,” “Employee Name” (including hire date), and “Zip Code” using information from ResultSet 10 and the metadata corresponding to ResultSet 10. Next, the primary key of the parent data object is determined from the metadata. In this case, for the relationship between “Department” and “Employee Name” in row 20 of ResultSet 10, the primary key of the parent data object is the department name, and the primary key has a value of “Shoe Department.”

At this point in the process, table registry 52 is examined to determine if the “Department” data object having the primary key value of “Shoe Department” exists therein. If the “Department” data object having the primary key value of “Shoe Department” exists in the table registry 50, it is retrieved from the table registry 50. If the “Department” data object having the primary key value of “Shoe Department” does not exist in the table registry 50, it is stored in the table registry 50. As shown in FIG. 4b, the set of data objects now include “Shoe Department,” “Employee Name” (including hire date), and “Zip Code.”

The above steps are repeated for the child data object of the relationship between “Department” and “Employee Name” in row 20 of ResultSet 10, resulting in the set of data objects “Shoe Department,” “Sam (10/27/1989),” and “Zip Code” shown in FIG. 4c. A link 54 has also been added between the parent data object “Shoe Department” and “Sam (10/27/1989).” After repeating this process for the parent-child relationship between “Sam” and zip code “27560” in row 20 of ResultSet 10, the set of data objects appears as depicted in FIG. 4d. As shown, for the relationship between “Employee Name” and “Zip Code” in row 20 of ResultSet 10, a link 56 has been added between the parent data object “Sam (10/27/1989)” and the child data object “27560.”

Row 22 of ResultSet 10 is then processed in the same manner. This results in the set of data objects depicted in FIG. 4e. As shown, for the relationship between “Department” and “Employee Name” in row 22 of ResultSet 10, a link 58 has been added between the parent data object “Hat Department” and the child data object “Burt (05/17/2001).” Similarly, for the relationship between “Employee Name” and “Zip Code” in row 22 of ResultSet 10, a link 60 has been added between the parent data object “Burt (05/17/2001)” and the child data object “27560.” Since the data object of “27560” already exists in the graph (i.e., it is listed in the table registry 50), it is not repeated in the graph. Extending the process to the entire ResultSet 10, the final graph 70 produced in accordance with the present invention is shown in FIG. 4f.

In the above example, a single “Shoe Department” data object is linked to employee data objects “Sam” and “Julie.” Similarly, a single “Hat Department” data object is linked to employee data objects “Burt,” “Jack,” and “Susan.” As such, in order to extract a list of the employees in the ResultSet 10 that work in the “Shoe department,” and to provide the list in a usable format, code such as that listed below could be used:
employees=shoeDepartment.getList(“employees”)
Thus, comparing this code with the specialized code of the prior art listed above, it will be readily apparent that it is much easier to extract information from a ResultSet using the method of the present invention.

From the graph 70, it should also be noted that the employee data objects “Sam,” “Burt,” and “Jack” are each linked to a single zip code data object, “27560,” while the employee data objects “Julie” and “Susan” are each linked to a single zip code data object “27709.” Thus, data objects are not duplicated in the final graph 70. Further, since all relationships are bidirectional, a plurality of parent data objects can be obtained from a single child object. For example, the three employee data objects “Sam,” “Burt,” and “Jack” can be obtained from the single zip code object, “27560.”

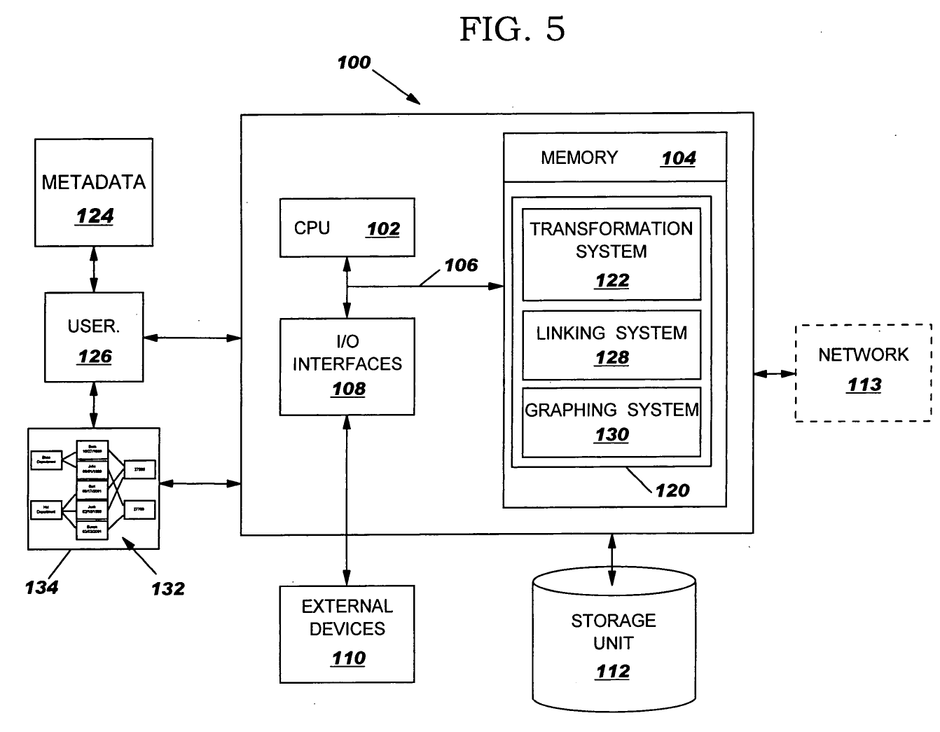

Referring now to FIG. 5, a computer system 100 capable of implementing the method of the present invention is illustrated in detail. As shown, the computer system 100 generally comprises a central processing unit (CPU) 102, memory 104, bus 106, input/output (I/O) interfaces 108, external devices/resources 110, and storage unit 112. CPU 102 may comprise a single processing unit, or may be distributed across one or more processing units in one or more locations. Memory 104 may comprise any known type of data storage and/or transmission media, including magnetic media, optical media, random access memory (RAM), read-only memory (ROM), a data cache, a data object, etc. Moreover, similar to CPU 102, memory 104 may reside at a single physical location, comprising one or more types of data storage, or may be distributed across a plurality of physical systems in various forms.

I/O interfaces 108 may comprise any system for exchanging information to/from an external source. External devices/resources 110 may comprise any known type of external device, including speakers, a CRT, LCD screen, handheld device, keyboard, mouse, voice recognition system, speech output system, printer, monitor/display, facsimile, pager, etc. Bus 106 provides a communication link between each of the components in computer system 100 and likewise may comprise any known type of transmission link, including electrical, optical, wireless, etc.

Storage unit 112 can be any system capable of providing storage for information necessary for the practice of the present invention. As such, storage unit 112 may reside at a single physical location, comprising one or more types of data storage, or may be distributed across a plurality of physical systems in various forms. In another embodiment, storage unit 112 may be distributed across, for example, a local area network (LAN), wide area network (WAN) or a storage area network (SAN), shown generically in FIG. 5 as network 113.

Shown in memory 104 of computer system 100 is a normalization system 120, which may be provided as computer program product. The normalization system 120 is provided to normalize database result sets, such as JDBC ResultSets, stored in storage unit 112. The normalization system 120 includes a transformation system 122 for transforming data within a database result set into data objects, based on the result set and metadata 124 corresponding to the result set. The metadata 124 can be provided by user 126 or in any other suitable manner. As described above, the metadata comprises a subset of a database schema used in the query that generated the result set.

The normalization system 120 further includes a linking system 128 for establishing links between the data objects generated by transformation system 122, by iterating through the relationships defined in the metadata 124. A graphing system 130 for generating a graph 132 of related data objects, which can be displayed to user 126 on display 134, is also provided. The table registry 52 used in this process can be stored in storage unit 112.

It should be appreciated that the teachings of the present invention could be offered as a business method on a subscription or fee basis. For example, computer system 100 could be created, maintained and/or deployed by a service provider that offers the functions described herein for customers. That is, a service provider could be used to normalize database result sets as describe above. It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagate signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for normalizing a database result set, comprising:
transforming a row in the database result set into a set of data objects using information from the database result set and metadata corresponding to the result set;
establishing links between the data objects by iterating through relationships defined in the metadata; and
generating a graph of related data objects based on the links.

2. The method of claim 1, wherein the database result set comprises a Java Database Connectivity (JDBC) ResultSet.

3. The method of claim 1, wherein the metadata comprises at least a portion of a database schema used in a query that resulted in generation of the database result set.

4. The method of claim 1, wherein establishing links between the data objects comprises:
(a) determining a parent/child relationship in a row of the database result set;
(b) determining a primary key of a parent data object in the parent/child relationship from the metadata;
(c) obtaining a value of the primary key from the parent data object;
(d) repeating steps (b) and (c) for a child data object in the parent/child relationship; and
(e) establishing a link between the parent child object and the child data object.

5. The method of claim 4, further comprising:
(f) repeating steps (a) through (e) for each parent/child relationship in the row of the database result set.

6. The method of claim 5, further comprising:
repeating steps (a) through (f) for each row in the database result set.

7. The method of claim 1, further comprising:
preventing data objects from being duplicated in the graph.

8. The method of claim 7, wherein preventing data objects from being duplicated in the graph further comprises:
using entries in a table registry to determine if a data object already exists in the graph.

9. A system for normalizing a database result set, comprising:
a system for transforming a row in the database result set into a set of data objects using information from the database result set and metadata corresponding to the result set;
a system for establishing links between the data objects by iterating through relationships defined in the metadata; and
a system for generating a graph of related data objects based on the links.

10. The system of claim 9, wherein the database result set comprises a Java Database Connectivity (JDBC) ResultSet.

11. The system of claim 9, wherein the metadata comprises at least a portion of a database schema used in a query that resulted in generation of the database result set.

12. The system of claim 9, wherein the system for establishing links between the data objects is configured to:
(a) determine a parent/child relationship in a row of the database result set;
(b) determine a primary key of a parent data object in the parent/child relationship from the metadata;
(c) obtain a value of the primary key from the parent data object;
(d) repeat steps (b) and (c) for a child data object in the parent/child relationship; and
(e) establish a link between the parent child object and the child data object.

13. The system of claim 12, wherein the system for establishing links between the data objects is further configured to:
(f) repeat steps (a) through (e) for each parent/child relationship in the row of the database result set.

14. The system of claim 13, wherein the system for establishing links between the data objects is further configured to:
repeat steps (a) through (f) for each row in the database result set.

15. The system of claim 9, further comprising:
a system for preventing data objects from being duplicated in the graph.

16. The system of claim 15, wherein the system for preventing data objects from being duplicated in the graph uses entries in a table registry to determine if a data object already exists in the graph.

17. A program product stored on a recordable medium for normalizing a database result set, which when executed, comprises:
program code for transforming a row in the database result set into a set of data objects using information from the database result set and metadata corresponding to the result set;
program code for establishing links between the data objects by iterating through relationships defined in the metadata; and
program code for generating a graph of related data objects based on the links.

18. The program product of claim 17, wherein the database result set comprises a Java Database Connectivity (JDBC) ResultSet.

19. The program product of claim 17, wherein the metadata comprises at least a portion of a database schema used in a query that resulted in generation of the database result set.

20. The program product of claim 17, wherein the program code for establishing links between the data objects is configured to:
(a) determine a parent/child relationship in a row of the database result set;
(b) determine a primary key of a parent data object in the parent/child relationship from the metadata;
(c) obtain a value of the primary key from the parent data object;
(d) repeat steps (b) and (c) for a child data object in the parent/child relationship; and
(e) establish a link between the parent child object and the child data object.

21. The program product of claim 20, wherein the program code for establishing links between the data objects is further configured to:
(f) repeat steps (a) through (e) for each parent/child relationship in the row of the database result set.

22. The program product of claim 21, wherein the program code for establishing links between the data objects is further configured to:
repeat steps (a) through (f) for each row in the database result set.

23. The program product of claim 17, further comprising:
program code for preventing data objects from being duplicated in the graph.

24. The program product of claim 23, wherein the program code for preventing data objects from being duplicated in the graph further comprises:
program code for using entries in a table registry to determine if a data object already exists in the graph.

25. A system for deploying an application for normalizing a database result set, comprising:
a computer infrastructure being operable to:
transform a row in the database result set into a set of data objects using information from the database result set and metadata corresponding to the result set;
establish links between the data objects by iterating through relationships defined in the metadata; and
generate a graph of related data objects based on the links.

26. Computer software embodied in a propagated signal for normalizing a database result set, the computer software comprising instructions to cause a computer system to perform the following functions:
transform a row in the database result set into a set of data objects using information from the database result set and metadata corresponding to the result set;
establish links between the data objects by iterating through relationships defined in the metadata; and
generate a graph of related data objects based on the links.
